(19) United States
(12) Patent Application Publication
(10) Pub. No.: US 2026/0196760 A1
(43) Pub. Date: Jul. 9, 2026

(54) ELECTRICAL CONNECTOR WITH ENGAGING PORTIONS TO RESTRICT TERMINAL MODULE

(71) Applicant: DONGGUAN LUXSHARE TECHNOLOGIES CO., LTD, Dongguan City (CN)

(72) Inventors: Xiaoping WU, Dongguan City (CN); Yuanxin WANG, Dongguan City (CN); Hongji CHEN, Dongguan City (CN)

(73) Assignee: DONGGUAN LUXSHARE TECHNOLOGIES CO., LTD., Dongguan City (CN)

(21) Appl. No.: 19/030,960

(22) Filed: Jan. 17, 2025

(30) Foreign Application Priority Data
Jan. 9, 2025 (CN) 202510038331.2

(51) Int. Cl. H01R 13/22; H01R 13/422; H01R 13/502; H01R 13/6581

(52) U.S. Cl. CPC H01R 13/22; H01R 13/502; H01R 13/6581; H01R 13/4223

(57) ABSTRACT

An electrical connector includes an insulating body and a first terminal module. The insulating body includes a receiving space and a first engaging portion disposed in the receiving space. The first terminal module is at least partially disposed in the receiving space. The first terminal module includes a second engaging portion. The second engaging portion is disposed between two first side portions of the first terminal module along a first direction. The second engaging portion engages with the first engaging portion. The first engaging portion and the second engaging portion abut against each other along a second direction. The present disclosure is beneficial to maintaining the consistency of the terminal height.

### CROSS-REFERENCE TO RELATED APPLICATION

This patent application claims priority of a Chinese Patent Application No. 202510038331.2, filed on Jan. 9, 2025 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

QSFP-DD (Quad Small Form-factor Pluggable Double Density) and SFP-DD (Small Form-factor Pluggable Double Density) modules in the relevant art include receptacle connectors. The receptacle connector includes an insulating body and four rows of terminals received in the insulating body. After the receptacle connector is assembled, due to the influence of stress or high temperature, it is easy to cause the terminal height to be inconsistent, affecting the quality and performance of the receptacle connector.

### SUMMARY

An object of the present disclosure is to provide an improved electrical connector.

The present disclosure adopts the following technical solution: an electrical connector, including: an insulating body, the insulating body including a receiving space and a first engaging portion disposed in the receiving space; and a first terminal module, the first terminal module being at least partially disposed in the receiving space, the first terminal module including two first side portions and a second engaging portion, the second engaging portion being located between the two first side portions of the first terminal module along a first direction; the second engaging portion engaging with the first engaging portion; and the first engaging portion and the second engaging portion abutting against each other along a second direction.

The present disclosure also adopts the following technical solution: an electrical connector, including: an insulating body, the insulating body including a mating port, a receiving space being in communication with the mating port, and a first engaging portion disposed in the receiving space; and a first terminal module, the first terminal module including a first insulating block and a plurality of first terminals fixed to the first insulating block, the first terminal module being at least partially disposed in the receiving space, the first insulating block including two first side portions and a second engaging portion located between the two first side portions of the first terminal module along a first direction; each first terminal including a first elastic arm extending into the mating port; wherein the first terminal module is at least partially assembled into the receiving space along a third direction; when the first terminal module is assembled in place, the first engaging portion and the second engaging portion abut against each other along a second direction, so that the first insulating block is prevented from deforming and protruding toward the mating portion, thereby keeping the first elastic arms of the plurality of first terminals at a same height; and wherein each two of the first direction, the second direction and the third direction are perpendicular to each other.

### BRIEF DESCRIPTION OF DRAWINGS

FIG. 1 is a perspective schematic view of an electrical connector in accordance with an embodiment of the present disclosure;

FIG. 2 is a perspective view of the electrical connector shown in FIG. 1 from another angle;

FIG. 3 is another perspective view of the electrical connector shown in FIG. 1;

FIG. 4 is an exploded schematic view of FIG. 2;

FIG. 5 is an exploded schematic view of FIG. 3;

FIG. 6 is a cross-sectional view of the electrical connector shown in FIG. 2;

FIG. 7 is an enlarged schematic view of area A in FIG. 6;

FIG. 8 is an exploded schematic view of FIG. 6;

FIG. 9 is a side view of a first terminal module and a second terminal module in FIG. 4;

FIG. 10 is a cross-sectional view of the electrical connector shown in FIG. 2;

FIG. 11 is an enlarged schematic view of area B in FIG. 10;

FIG. 12 is an exploded schematic view of the first terminal module and the second terminal module in FIG. 4;

FIG. 13 is an exploded schematic view of the first terminal module and the second terminal module in FIG. 5;

FIG. 14 is a perspective view of an insulating body in FIG. 4;

FIG. 15 is an exploded schematic view of a first insulating block, a second insulating block, a plurality of first terminals, a first shielding piece, and a second shielding piece in FIG. 12;

FIG. 16 is an exploded schematic view of a third insulating block, a plurality of second terminals, and a third shielding piece in FIG. 12;

FIG. 17 is an exploded schematic view of a fourth insulating block, a plurality of third terminals, and a fourth shielding piece in FIG. 13; and

FIG. 18 is an exploded schematic view of a fifth insulating block, a plurality of fourth terminals, and a fifth shielding piece in FIG. 13.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

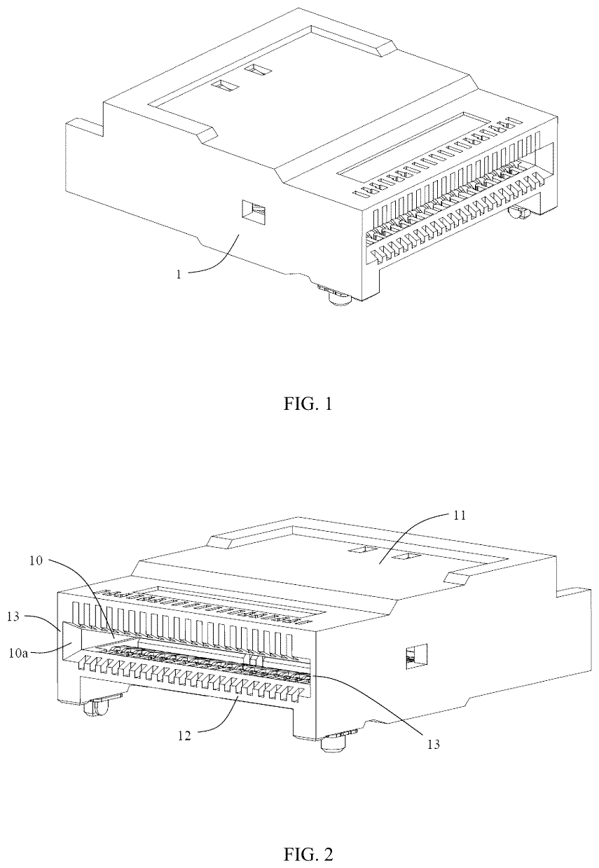

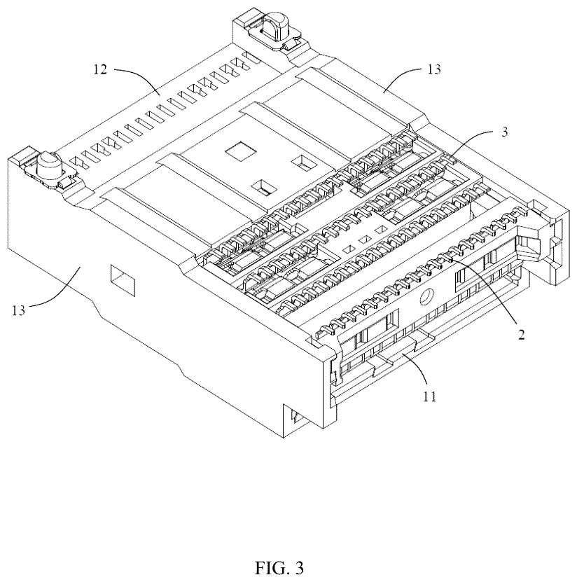

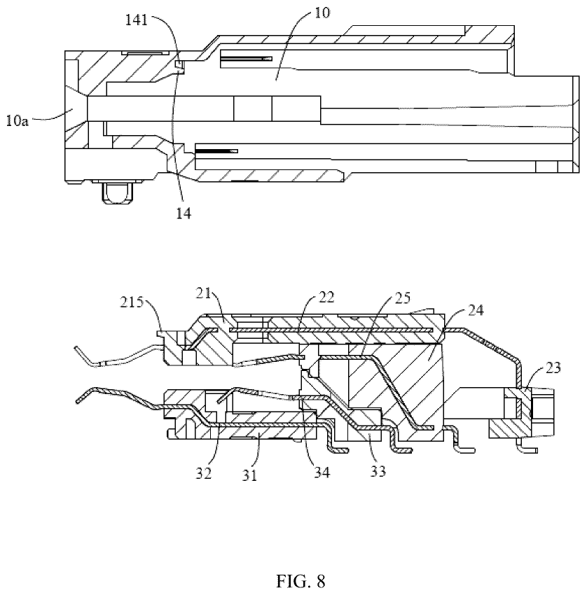

Referring to FIG. 1 to FIG. 18, the present disclosure discloses an electrical connector including an insulating body 1, a first terminal module 2 and a second terminal module 3. The insulating body 1 has a receiving space 10 and a mating port 10a. The first terminal module 2 and the second terminal module 3 are at least partially disposed in the receiving space 10. The mating portion 10a is configured for plugging in a mating connector (not shown).

Referring to FIG. 2 to FIG. 4, the insulating body 1 includes a top wall portion 11, a bottom wall portion 12 disposed opposite to the top wall portion 11, and two side wall portions 13. The two side wall portions 13 connect two sides of the top wall portion 11 and the bottom wall portion 12, respectively. The top wall portion 11, the bottom wall portion 12 and the two side wall portions 13 together form the receiving space 10.

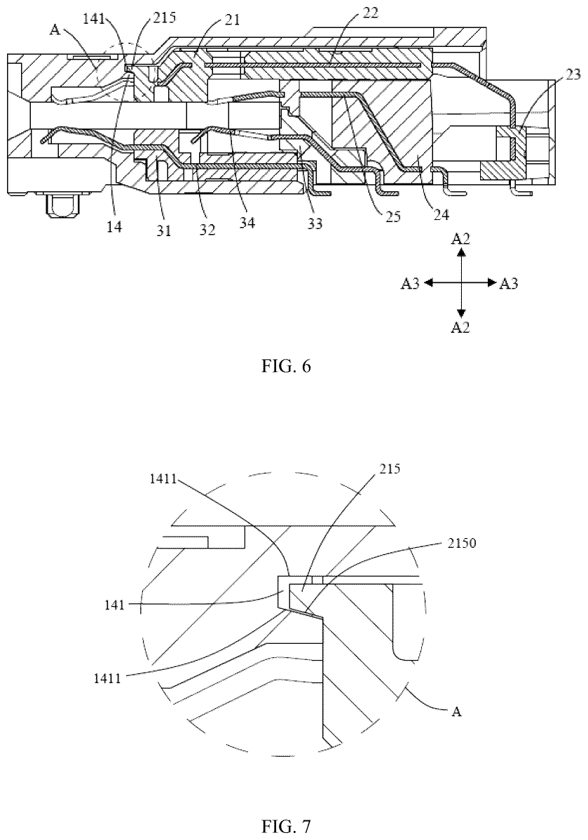

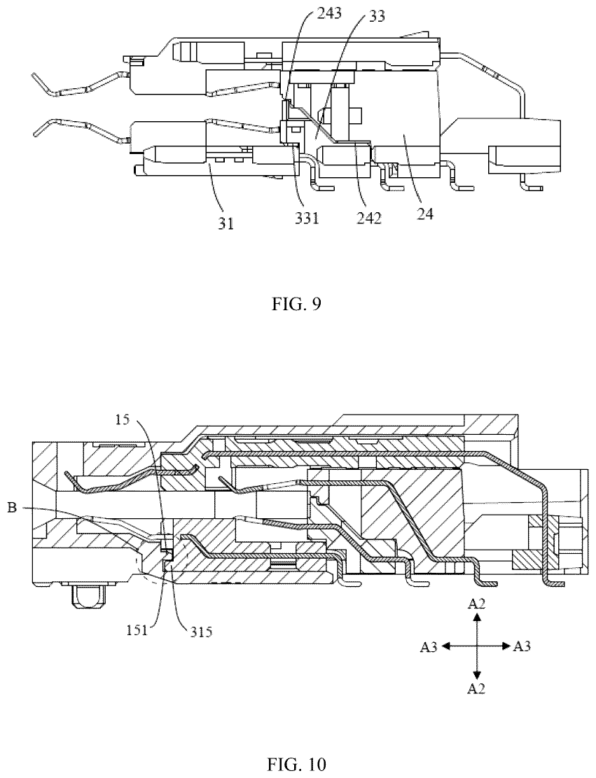

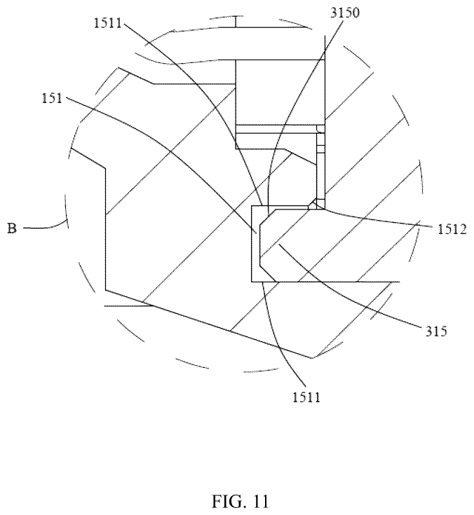

Referring to FIG. 6 to FIG. 8, the top wall portion 11 of the insulating body 1 includes a first engaging portion 14 disposed in the receiving space 10. The first terminal module 2 includes two first side portions 211 and a second engaging portion 215. The second engaging portion 215 is located between the two first side portions 211 of the first terminal module 2 along a first direction A1-A1. The second engaging portion 215 engages with the first engaging portion 14, and the first engaging portion 14 and the second engaging portion 215 abut against each other along a second direction A2-A2. The second direction A2-A2 is perpendicular to the first direction A1-A1. Referring to FIG. 10 and FIG. 11, the bottom wall portion 12 of the insulating body 1 includes a fifth engaging portion 15 disposed in the receiving space 10. The second terminal module 3 includes two second side portions 311 and a sixth engaging portion 315. The sixth engaging portion 315 is located between the two second side portions 311 of the second terminal module 3 along the first direction A1-A1. The sixth engaging portion 315 engages with the fifth engaging portion 15, and the fifth engaging portion 15 and the sixth engaging portion 315 abut against each other along the second direction A2-A2. In an illustrated embodiment of the present disclosure, the first direction A1-A1 refers to a left-right direction of the electrical connector; and the second direction A2-A2 refers to a top-bottom direction of the electrical connector. The first terminal module 2 and the second terminal module 3 are disposed along the top-bottom direction of the electrical connector. By the second engaging portion 215 and the first engaging portion 14 abutting against each other, and by the sixth engaging portion 315 and the fifth engaging portion 15 abutting against each other, the present disclosure solves the deformation problem of the first terminal module 2 and the second terminal module 3 in the second direction A2-A2, which is conducive to maintaining the consistency of the terminal height.

Referring to FIG. 6 to FIG. 8, the first engaging portion 14 defines a first engaging groove 141. The second engaging portion 215 is a protruding structure extending from the first terminal module 2 along a third direction A3-A3. The second engaging portion 215 extends into the first engaging groove 141. In the illustrated embodiment of the present disclosure, the third direction A3-A3 refers to a front-back direction of the electrical connector. Of course, in some other embodiments, the first engaging portion 14 and the second engaging portion 215 may exchange positions. For example, the first terminal module 2 may be provided with a structure similar to the first engaging portion 14, and the insulating body 1 may be provided with a structure similar to the second engaging portion 215. As long as the first terminal module 2 and the insulating body 1 can be engaged with each other, structures thereof are not limited in the embodiments of the present disclosure.

Referring to FIG. 10 and FIG. 11, the fifth engaging portion 15 defines a second engaging groove 151. The sixth engaging portion 315 is a protruding structure extending from the second terminal module 3 along the third direction A3-A3. The sixth engaging portion 315 extends into the second engaging groove 151. Of course, in some other embodiments, the fifth engaging portion 15 and the sixth engaging portion 315 may exchange positions. For example, the second terminal module 3 may be provided with a structure similar to the fifth engaging portion 15, and the insulating body 1 may be provided with a structure similar to the sixth engaging portion 315. As long as the second terminal module 3 and the insulating body 1 can be engaged with each other, structures thereof are not limited in the embodiments of the present disclosure.

Referring to FIG. 7, the first engaging portion 14 includes two first groove surfaces 1411 disposed on opposite sides of the first engaging groove 141, respectively. The two first groove surfaces 1411 are configured to support the second engaging portion 215. Referring to FIG. 11, the fifth engaging portion 15 includes two second groove surfaces 1511 disposed on opposite sides of the second engaging groove 151, respectively, along the second direction A2-A2. The second engaging portion 215 is supported by the first groove surface 1411, and the sixth engaging portion 315 is supported by the second groove surface 1511, so that the first terminal module 2 and the second terminal module 3 are less likely to deform in the second direction A2-A2, which is beneficial to maintaining the consistency of the terminal height.

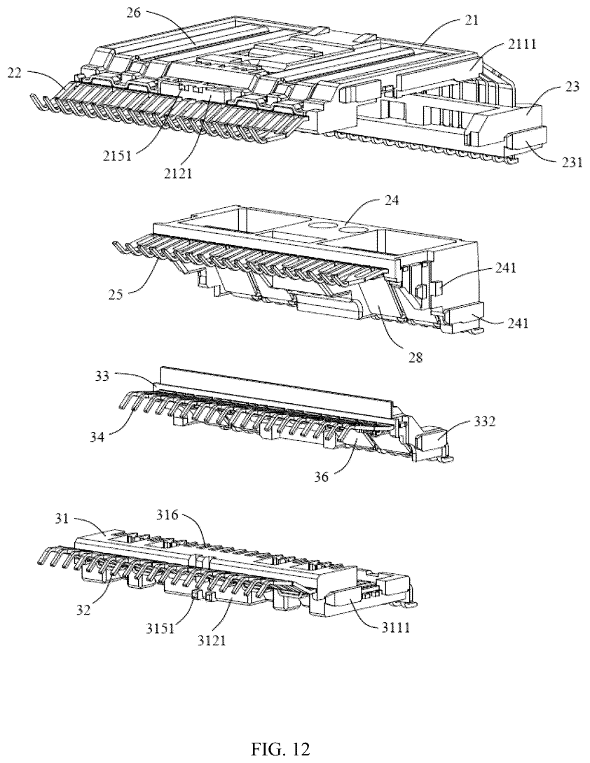

In some embodiments, referring to FIG. 12, the second engaging portion 215 includes two first protrusions 2151 that are spaced apart. Correspondingly, the first engaging portion 14 defines two first engaging grooves 141. Of course, in other possible embodiments, the second engaging portion 215 may include only one first protrusion 2151, or the second engaging portion 215 may include three first protrusions 2151 arranged at intervals. In the present disclosure, the specific number of the first protrusions 2151 is not limited.

In some embodiments, referring to FIG. 12, the sixth engaging portion 315 includes two second protrusions 3151 that are spaced apart. Correspondingly, the fifth engaging portion 15 includes two second engaging grooves 151. Of course, in other possible embodiments, the sixth engaging portion 315 may include only one second protrusion 3151, or the sixth engaging portion 315 may include three second protrusions 3151 arranged at intervals. In the present disclosure, the specific number of the second protrusions 3151 is not limited.

Lengths of the first protrusion 2151 and the second protrusion 3151 along the first direction A1-A1 can be adjusted as needed. For example, when a size of the first terminal module 2 and a size of the second terminal module 3 along the first direction A1-A1 are large, on the basis that the number remains unchanged, the lengths of the first protrusion 2151 and the second protrusion 3151 can be appropriately increased, thereby increasing the support effect. Of course, the number of the first protrusions 2151 and the second protrusions 3151 can also be increased to increase the supporting effect.

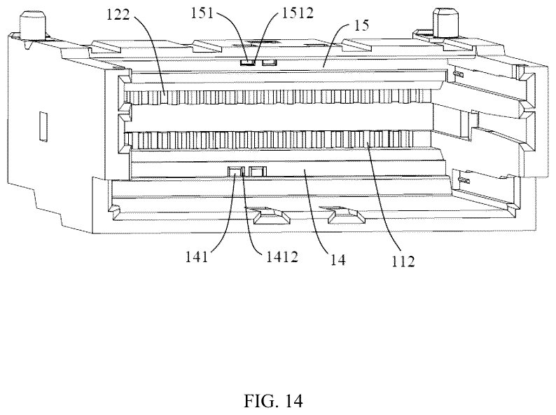

Referring to FIG. 7, the second engaging portion 215 is provided with a first guide surface 2150 that is inclined relative to the third direction A3-A3. Referring to FIG. 14, an opening of the first engaging groove 141 is provided with a second guide surface 1412 that is inclined relative to the third direction A3-A3. By providing the first guide surface 2150 and the second guide surface 1412, when the second engaging portion 215 and the first engaging groove 141 are inserted into each other, a guiding function can be achieved. Referring to FIG. 11, the sixth engaging portion 315 is provided with a third guide surface 3150 that is inclined relative to the third direction A3-A3. An opening of the second engaging groove 151 is provided with a fourth guide surface 1512 that is inclined relative to the third direction A3-A3. By providing the third guide surface 3150 and the fourth guide surface 1512, when the sixth engaging portion 315 and the second engaging groove 151 are inserted into each other, a guiding function can be achieved.

At least one of the two surfaces of the first protrusion 2151 and the two first groove surfaces 1411 is the inclined first guide surface 2150. In the present embodiment, referring to FIG. 7, a surface of the first protrusion 2151 facing the second terminal module 3 is the inclined first guide surface 2150. Correspondingly, the first groove surface 1411 that cooperates with the first guide surface 2150 is also an inclined surface. Referring to FIG. 11, the third guide surface 3150 is formed by providing a chamfer at a free end of the second protrusion 3151.

The structures of the first protrusion 2151 and the second protrusion 3151 may also be the same. For example, the second protrusion 3151 is configured in a shape similar to the first protrusion 2151. Alternatively, the first protrusion 2151 is provided in a shape similar to the second protrusion 3151.

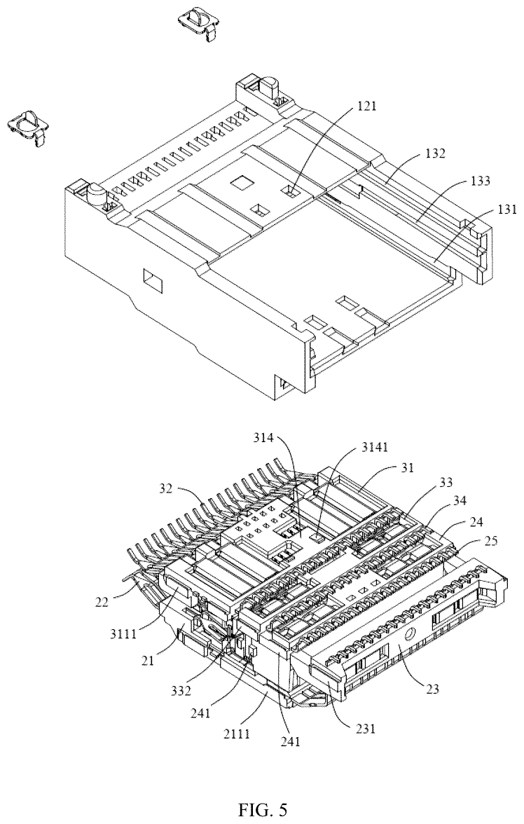

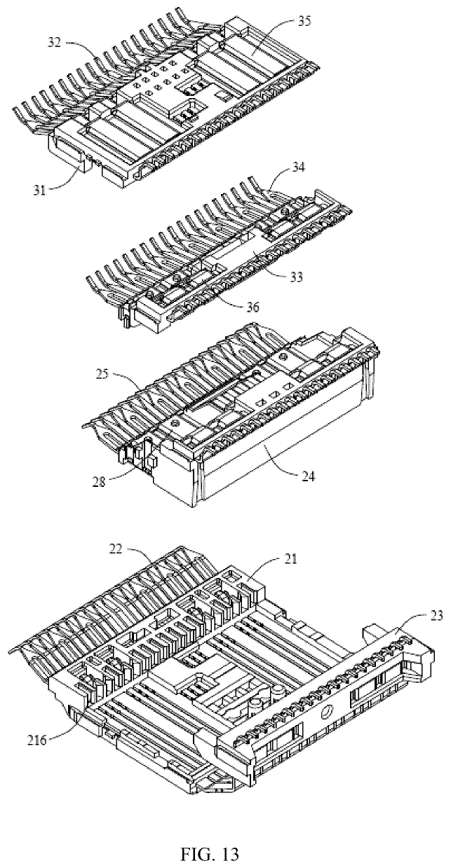

Referring to FIG. 5, FIG. 12 and FIG. 13, the first terminal module 2 includes a first insulating block 21, a plurality of first terminals 22, a second insulating block 23, a third insulating block 24 and a plurality of second terminals 25. The plurality of the first terminals 22 are fixed to the first insulating block 21 and the second insulating block 23. The first insulating block 21 is closer to the mating port 10a than the second insulating block 23. The first insulating block 21 is connected to the top wall portion 11 of the insulating body 1. The third insulating block 24 is disposed on a side of the first insulating block 21 facing away from the top wall portion 11. The plurality of second terminals 25 are disposed in the third insulating block 24. Specifically, the first terminals 22 are insert-molded with the first insulating block 21 and the second insulating block 23 to be integrated as a whole. The second terminals 25 are insert-molded with the third insulating block 24 to be integrated as a whole.

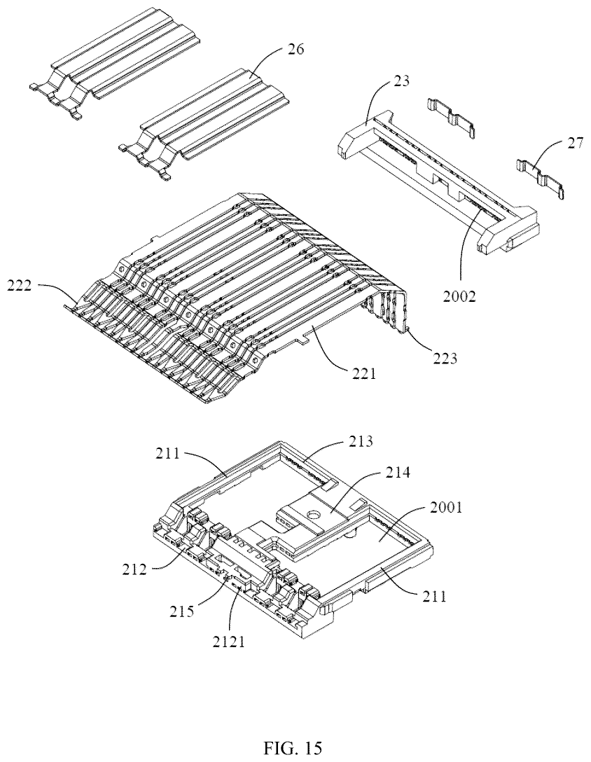

Referring to FIG. 15, the first insulating block 21 includes two first side portions 211 and a first end portion 212 connecting one ends of the two first side portions 211, a second end portion 213 connecting another ends of the two first side portions 211, and a first block 214 disposed between the two first side portions 211 and connecting the first end portion 212 and the second end portion 213. The second engaging portion 215 is provided on a first resisting platform 2121 of the first end portion 212. The first resisting platform 2121 is located in a middle area of the first end portion 212. The second engaging portion 215 is located in a middle area of the first insulating block 21. The second engaging portion 215 supports the middle area of the first insulating block 21 so that the forces on both sides of the first insulating block 21 are balanced and deformation is less likely to occur.

Along the first direction A1-A1, a length of the second engaging portion 215 does not exceed a length of the first resisting platform 2121. That is, one or more of the first protrusions 2151 may extend along the entire first resisting platform 2121, but do not protrude beyond the first resisting platform 2121 along the first direction A1-A1.

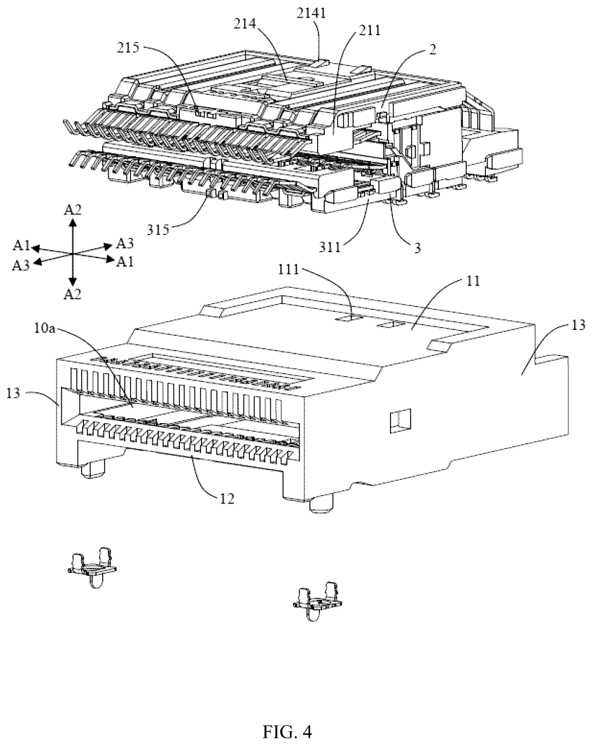

Referring to FIG. 4, the first block 214 is provided with a third engaging portion 2141. The top wall portion 11 of the insulating body 1 is provided with a first engaging opening 111. The third engaging portion 2141 protrudes into the first engaging opening 111 to restrict the first insulating block 21 from moving backwardly in the receiving space 10. Specifically, the third engaging portion 2141 has a trapezoidal structure. A height of a rear end of the third engaging portion 2141 is greater than a height of a front end of the third engaging portion 2141, which facilitates the third engaging portion 2141 to engage in the first engaging opening 111.

Referring to FIG. 5, the first side portion 211 is provided with a fourth engaging portion 2111. The side wall portion 13 of the insulating body 1 defines a first mounting groove 131. The first mounting groove 131 is in communication with the receiving space 10. The fourth engaging portion 2111 is disposed in the first mounting groove 131 to restrict the first insulating block 21 from moving forwardly in the receiving space 10. In addition, the first resisting platform 2121 and the first engaging portion 14 resist each other, which also restricts the first insulating block 21 from moving forwardly in the receiving space 10.

Continuing to refer to FIG. 5, a plurality of seventh engaging portions 231 are provided on two sides of the second insulating block 23. Two rows of eighth engaging portions 241 are provided on two sides of the third insulating block 24. The side wall portion 13 of the insulating body 1 defines a second mounting groove 132 and a third mounting groove 133. The seventh engaging portions 231 and one row of the eighth engaging portions 241 are both disposed in the second mounting groove 132 to restrict the second insulating block 23 and the third insulating block 24 from moving forwardly in the receiving space 10. Another row of eighth engaging portions 241 are disposed in the third mounting groove 133 to restrict the third insulating block 24 from moving forwardly in the receiving space 10.

Referring to FIG. 15, the first terminal 22 includes a first holding portion 221, a first elastic arm 222 connected to one end of the first holding portion 221, and a first tail portion 223 connected to another end of the first holding portion 221. The first insulating block 21 and the second insulating block 23 are over-molded at different positions of the first holding portion 221. Referring to FIG. 14, the top wall portion 11 of the insulating body 1 defines a plurality of first grooves 112. A plurality of the first elastic arms 222 are at least partially disposed in the plurality of the first grooves 112.

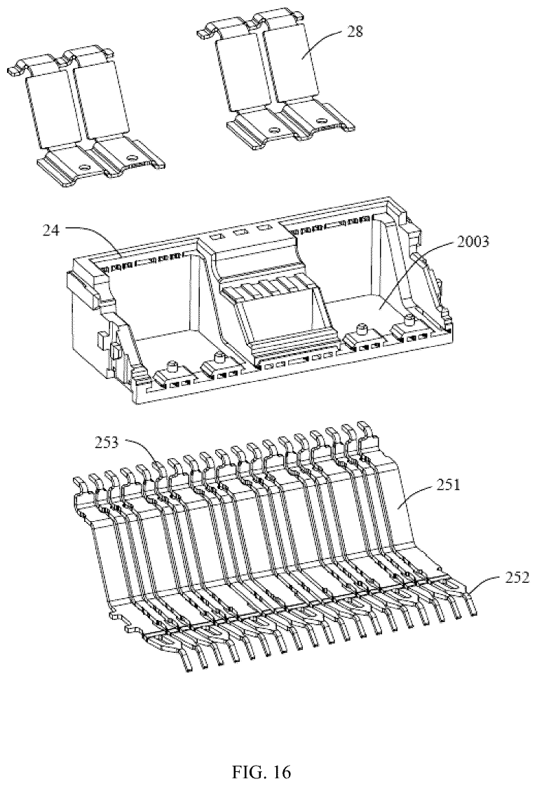

Referring to FIG. 16, the second terminal 25 includes a second holding portion 251, a second elastic arm 252 connected to one end of the second holding portion 251, and a second tail portion 253 connected to another end of the second holding portion 251. The third insulating block 24 is over-molded on the second holding portion 251. Referring to FIG. 13, the first insulating block 21 defines a plurality of second grooves 216. The plurality of second elastic arms 252 are at least partially disposed in the plurality of second grooves 216.

Referring to FIG. 15 and FIG. 16, the first terminal module 2 includes two first shielding pieces 26, two second shielding pieces 27 and two third shielding pieces 28. The first insulating block 21 defines two first through holes 2001 which are located on two sides of the first block 214. The two first shielding pieces 26 are provided in the two first through holes 2001 and shield an outside of the first holding portion 221. The second insulating block 23 defines two second through holes 2002. The two second shielding pieces 27 are disposed in the two second through holes 2002 and shield an outside of the first holding portion 221. The third insulating block 24 defines two third through holes 2003. The two third shielding pieces 28 are disposed in the two third through holes 2003 and shield an outside of the second holding portion 251.

Referring to FIG. 5 to FIG. 8, the second terminal module 3 includes a fourth insulating block 31, a plurality of third terminals 32, a fifth insulating block 33 and a plurality of fourth terminals 34. The plurality of third terminals 32 are fixed in the fourth insulating block 31. The plurality of fourth terminals 34 are fixed in the fifth insulating block 33. The fourth insulating block 31 is closer to the mating port 10a than the fifth insulating block 33. The fourth insulating block 31 is connected to the bottom wall portion 12 of the insulating body 1. Referring to FIG. 9, the third insulating block 24 defines a first positioning groove 242 and a second positioning groove 243. The first positioning groove 242 and the second positioning groove 243 are respectively configured to receive different parts of the fifth insulating block 33. The fifth insulating block 33 defines a third positioning groove 331. The fourth insulating block 31 is at least partially disposed in the third positioning groove 331 to achieve positioning connection among the third insulating block 24, the fourth insulating block 31 and the fifth insulating block 33.

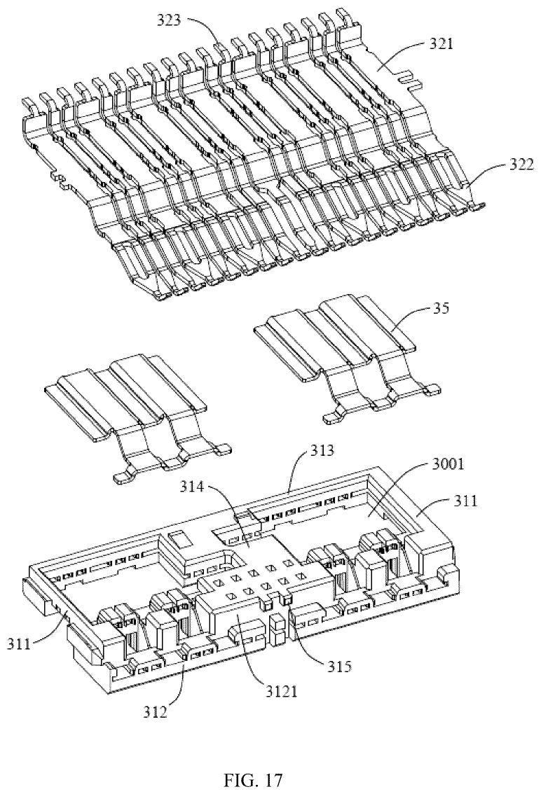

Referring to FIG. 17, the fourth insulating block 31 includes two second side portions 311, a third end portion 312 connecting one ends of the two second side portions 311, a fourth end portion 313 connecting another ends of the two second side portions 311, and a second block 314 located between the two second side portions 311 and connecting the third end portion 312 and the fourth end portion 313. The sixth engaging portion 315 is provided on a second resisting platform 3121 of the third end portion 312. The second resisting platform 3121 is located in a middle area of the third end portion 312. The sixth engaging portion 315 is located in a middle area of the fourth insulating block 31. The sixth engaging portion 315 supports the middle area of the fourth insulating block 31 so that the force on both sides of the fourth insulating block 31 is balanced and is less likely to deform.

Referring to FIG. 5, the second block 314 is provided with a ninth engaging portion 3141. The bottom wall portion 12 of the insulating body 1 defines a second engaging opening 121. The ninth engaging portion 3141 protrudes into the second engaging opening 121 to restrict the fourth insulating block 31 from moving backwardly in the receiving space 10. Specifically, the ninth engaging portion 3141 has a trapezoidal structure. A height of a rear end of the ninth engaging portion 3141 is greater than a height of a front end of the ninth engaging portion 3141, which facilitates the ninth engaging portion 3141 to engage in the second engaging opening 121.

Referring to FIG. 5, the second side portion 311 is provided with a tenth engaging portion 3111. The tenth engaging portion 3111 is disposed in the second mounting groove 132 to restrict the fourth insulating block 31 from moving forwardly in the receiving space 10. In addition, the second resisting platform 3121 and the fifth engaging portion 15 resist against each other, which also restricts the fourth insulating block 31 from moving forwardly in the receiving space 10.

Referring to FIG. 5, a plurality of eleventh engaging portions 332 are provided on both sides of the fifth insulating block 33. The eleventh engaging portion 332 is disposed in the second mounting groove 132 to restrict the fifth insulating block 33 from moving forwardly in the receiving space 10.

Referring to FIG. 17, the third terminal 32 includes a third holding portion 321, a third elastic arm 322 connected to one end of the third holding portion 321, and a third tail portion 323 connected to another end of the third holding portion 321. The fourth insulating block 31 is over-molded on the third holding portion 321. Referring to FIG. 14, the bottom wall portion 12 of the insulating body 1 defines a plurality of third grooves 122. The plurality of the third elastic arms 322 are at least partially disposed in the plurality of the third grooves 122.

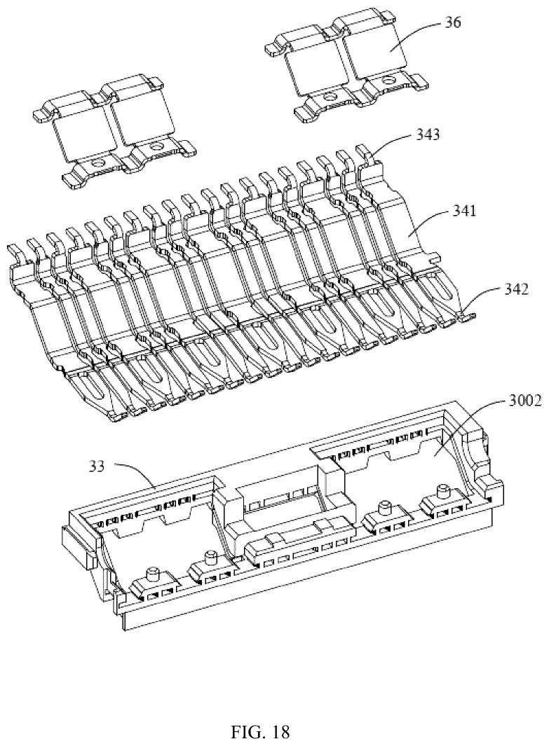

Referring to FIG. 18, the fourth terminal 34 includes a fourth holding portion 341, a fourth elastic arm 342 connected to one end of the fourth holding portion 341, and a fourth tail portion 343 connected to another end of the fourth holding portion 341. The fifth insulating block 33 is over-molded on the fourth holding portion 341. Referring to FIG. 12, the fourth insulating block 31 defines a plurality of fourth grooves 316. The plurality of the fourth elastic arms 342 are at least partially disposed in the plurality of the fourth grooves 316.

Referring to FIG. 17 and FIG. 18, the second terminal module 3 includes two fourth shielding pieces 35 and two fifth shielding pieces 36. The fourth insulating block 31 defines two fourth through holes 3001 which are located on both sides of the second block 314. The two fourth shielding pieces 35 are disposed in the two fourth through holes 3001 and shield an outside of the third holding portion 321. The fifth insulating block 33 defines two fifth through holes 3002. The two fifth shielding pieces 36 are disposed in the two fifth through holes 3002 and shield an outside of the fourth holding portion 341.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
an insulating body, the insulating body comprising a receiving space and a first engaging portion disposed in the receiving space; and
a first terminal module, the first terminal module being at least partially disposed in the receiving space, the first terminal module comprising two first side portions and a second engaging portion, the second engaging portion being located between the two first side portions of the first terminal module along a first direction; the second engaging portion engaging with the first engaging portion; and the first engaging portion and the second engaging portion abutting against each other along a second direction.

2. The electrical connector according to claim 1, wherein the first engaging portion defines a first engaging groove; the second engaging portion is a protruding structure extending in a third direction from the first terminal module.

3. The electrical connector according to claim 2, wherein the first engaging portion comprises two first groove surfaces which are disposed on opposite sides of the first engaging groove, respectively; the two first groove surfaces are configured to support the second engaging portion.

4. The electrical connector according to claim 2, wherein the second engaging portion is provided with a first guide surface inclined relative to the third direction; an opening of the first engaging groove is provided with a second guide surface inclined relative to the third direction.

5. The electrical connector according to claim 1, wherein the first terminal module comprises a first insulating block and a plurality of first terminals fixed to the first insulating block; the first insulating block comprises the two first side portions and a first end portion connecting one sides of the two first side portions; the second engaging portion is provided on a first resisting platform of the first end portion; and the first resisting platform is located in a middle area of the first end portion.

6. The electrical connector according to claim 5, wherein along the first direction, a length of the second engaging portion does not exceed a length of the first resisting platform.

7. The electrical connector according to claim 5, wherein the first insulating block comprises a second end portion connecting another ends of the two first side portions, and a first block located between the two first side portions and connecting the first end portion and the second end portion; the first block is provided with a third engaging portion; the insulating body defines a first engaging opening; the third engaging portion protrudes into the first engaging opening.

8. The electrical connector according to claim 7, wherein the first side portion is provided with a fourth engaging portion; the insulating body defines a first mounting groove in communication with the receiving space; the fourth engaging portion is received in the first mounting groove.

9. The electrical connector according to claim 7, wherein the first terminal module comprises two first shielding pieces; and the two first shielding pieces shield the first terminals on two sides of the first block.

10. The electrical connector according to claim 9, further comprising a second terminal module; the second terminal module being at least partially disposed in the receiving space; the insulating body being provided with a fifth engaging portion; the second terminal module being provided with two second side portions and a sixth engaging portion; the sixth engaging portion being disposed between the two second side portions of the second terminal module along the first direction; the sixth engaging portion and the fifth engaging portion engaging with each other; the fifth engaging portion and the sixth engaging portion abutting against each other along the second direction.

11. The electrical connector according to claim 1, wherein the first direction and the second direction are perpendicular to each other.

12. An electrical connector, comprising:
an insulating body, the insulating body comprising a mating port, a receiving space being in communication with the mating port, and a first engaging portion disposed in the receiving space; and
a first terminal module, the first terminal module comprising a first insulating block and a plurality of first terminals fixed to the first insulating block, the first terminal module being at least partially disposed in the receiving space, the first insulating block comprising two first side portions and a second engaging portion located between the two first side portions of the first terminal module along a first direction; each first terminal comprising a first elastic arm extending into the mating port;
wherein the first terminal module is at least partially assembled into the receiving space along a third direction; when the first terminal module is assembled in place, the first engaging portion and the second engaging portion abut against each other along a second direction, so that the first insulating block is prevented from deforming and protruding toward the mating portion, thereby keeping the first elastic arms of the plurality of first terminals at a same height; and
wherein each two of the first direction, the second direction and the third direction are perpendicular to each other.

13. The electrical connector according to claim 12, wherein the first engaging portion defines a first engaging groove; the second engaging portion is a protruding structure extending in the third direction from the first terminal module.

14. The electrical connector according to claim 13, wherein the first engaging portion comprises two first groove surfaces which are disposed on opposite sides of the first engaging groove, respectively; at least one of the two first groove surfaces is configured to support the second engaging portion.

15. The electrical connector according to claim 13, wherein the second engaging portion is provided with a first guide surface inclined relative to the third direction; an opening of the first engaging groove is provided with a second guide surface inclined relative to the third direction.

16. The electrical connector according to claim 12, wherein the first insulating block comprises a first end portion connecting one sides of the two first side portions; the second engaging portion is provided on a first resisting platform of the first end portion; and the first resisting platform is located in a middle area of the first end portion.

17. The electrical connector according to claim 16, wherein the first insulating block comprises a second end portion connecting another ends of the two first side portions, and a first block located between the two first side portions and connecting the first end portion and the second end portion; the first block is provided with a third engaging portion; the insulating body defines a first engaging opening; the third engaging portion protrudes into the first engaging opening.

18. The electrical connector according to claim 17, wherein the first side portion is provided with a fourth engaging portion; the insulating body defines a first mounting groove in communication with the receiving space; the fourth engaging portion is received in the first mounting groove.

19. The electrical connector according to claim 17, wherein the first terminal module comprises two first shielding pieces; and the two first shielding pieces shield the first terminals on two sides of the first block.

20. The electrical connector according to claim 19, further comprising a second terminal module; the second terminal module being at least partially disposed in the receiving space; the insulating body being provided with a fifth engaging portion; the second terminal module being provided with two second side portions and a sixth engaging portion; the sixth engaging portion being disposed between the two second side portions of the second terminal module along the first direction; the sixth engaging portion and the fifth engaging portion engaging with each other; the fifth engaging portion and the sixth engaging portion abutting against each other along the second direction.
